(19) United States
(12) Patent Application Publication
(10) Pub. No.: US 2007/0016940 A1
(43) Pub. Date: Jan. 18, 2007

(54) Identification and password management device

(75) Inventors: John Yearty, Tallahassee, FL (US); James Yearty, Tallahassee, FL (US)

Correspondence Address: WILLIAM H. HOLLIMON;MOYLE, FLANIGAN, KATZ, RAYMOND & SHEEHAN, P.A., 118 N. GADSDEN STREET, TALLAHASSEE, FL, 32301, US

(73) Assignee: JDI Ventures, Inc. d/b/a Peak Performance Solutions

(21) Appl. No.: 11/178,059

(22) Filed: Jul. 8, 2005

(51) Int. Cl. H04L 9/32

(52) U.S. Cl. 726/5

(57) ABSTRACT

A password management device which provides for the secure storage and retrieval of passwords. Such a password management device includes the ability to generate and store passwords generated by an included random number generator and requires user identification through the input and validation of biometric information prior to accessing password storage and retrieval functions. The password management device may also include on-board storage of access control information that is selectively transmitted to access control readers upon user biometric information verification and the capability of receiving photographic and textual information on the exterior of the password management device.

### BACKGROUND OF THE INVENTION

This invention relates to the field of portable information processing systems and methods, and, in particular, to the field of workplace security as applied to employee identification and to employee password security methods and systems. This invention relates to a simple, compact, stand-alone system, and method for its use, that allows employees to carry a single card that satisfies the requirements of employee identification, security and access control, and password management.

Security of information stored on computer systems is a critical concern to individuals, businesses, and governments. Accordingly, many databases and other data storage systems require a user to perform an identity validation/verification process to gain access to these systems. Typically, this is accomplished in one of two manners. First, some computer systems require user verification through the input of some form of biometric information. This is typically accomplished by associating a biometric input device at each computer that has access to the information to be protected. The problems with this method include the cost of providing a biometric input device at each computer and the inherent security risk of storing biometric information on a server that is accessible by multiple people and open to possible intrusion. Further, in many instances, biometric data is required to be passed across public networks to be verified at the server.

The second, and more common method, requires a user to enter a unique password to gain access to these systems. To increase the security of these passwords, many such systems require that passwords be composed of a random combination of numbers, letters, and/or symbols so that these passwords are much more difficult to decrypt. These passwords generally require a minimum of eight characters. Further, these systems generally require users to change their passwords on a regular basis to enhance the continued security of the system.

Users of password protected systems, therefore, are required to keep track of long, random, frequently-changing passwords that are difficult, if not impossible, to remember. As a result, many employees keep an unencrypted written list of passwords that is often kept on their person or in close proximity to their computers. This, and similar practices, significantly compromise the security of critical information, and make it much more likely that passwords may be obtained by persons who are not authorized to possess such passwords, and that these passwords will be used to compromise sensitive information.

Many employees in government, industry, and business are also required to display photo identification at all times. Typically, these photo identification cards display the employee's name, picture, title, department, etc., and many times include programmable data-storage capabilities, such that an appropriate interface device can be used to scan the identification card for access control and other security purposes. For example, an identification card may include a magnetic strip upon which data can be stored and read by a magnetic strip reader, or may include radio frequency identification (RFID) tags and labels. RFID tags and labels have a combination of antennas, analog and/or digital electronics, and often are associated with software for handling data. RFID tags and labels are widely used to associate an object with an identification code.

Information is storable on the RFID chip. To retrieve the information from the chip, a RFID reader, or “base station,” sends an excitation signal to the RFID tag or label. The excitation signal energizes the tag or label, and the RFID circuitry transmits the stored information back to the reader. The reader receives and decodes the information from the RFID tag or label.

These combination identification and security cards are well known in the art and are ubiquitous in the modern workplace. However, such cards do not include secure password management capabilities, and do not address the problem of keeping employee passwords secure. Additionally, these identification cards are stand-alone devices that, if misappropriated, may be used by unauthorized persons to obtain access to otherwise controlled or secure areas or information.

For the foregoing reasons, there is a need for a simple, effective, low-cost, stand-alone device that combines the requirements of employee identification, access control, security, and password management into a single identification and password management device (“IPMD”). Alternatively, there may be circumstances where it is not practical to integrate employee identification and security functions into a single device that also provides password management functions. Thus, there is also a need for a simple, effective, low-cost, stand-alone password management device that readily incorporates with existing identity and security devices in a manner that makes use of the two devices convenient, simple, and non-obstructive.

### SUMMARY

It is therefore an object of the present invention to provide a device that can be used to meet workplace requirements related to data security, password management, access control, and employee identification. It is another object of the present invention to provide the capability to integrate employee identification, access control, security, and password management into a single device, or to provide a convenient, simple method of associating the functions of employee identification and access control with password management. It is another object of the present invention to provide a device which utilizes biometric data to verify user identity before allowing access to the password management functions of the device. It is a further object of the present invention to provide a device that directly substitutes for the current, widely used, employee identification cards, without adding significantly to the size or reducing the reliability of such cards. It is a further object of the present invention to associate biometric information with access control information to ensure that only authorized users may obtain access to secured areas.

The present invention is a compact device that includes a printable surface for receiving employee identification information, a biometric input device such as a fingerprint reader for verifying employee identity; programmable means for storing access control information such as a magnetic stripe or an RFID chip; a central processing unit (CPU) for processing biometric information, providing password storage and creation functionality, and controlling the release of access control information; memory for storing application software, biometric information, and passwords; a display for viewing password information; an input interface to access password functionality; software for generating random, secure passwords; and a power supply that may be photovoltaic or battery, or a combination of the two. Alternatively, the device may include a built-in clip or retainer system that allows for the easy integration of the device with a standard employee identification card in circumstances where it is not desirable to integrate employee identification information.

The present invention is preferably a credit card sized device that is similar in dimension to the well-known employee identification card that is currently in wide use. The device is printable via well-known photo-identification printing systems, such that an employee's picture, other personal identifying information, and employer information can be printed on the surface of the device. Upon issuance to an employee, the card is printed with employee and employer specific information, and security and access control information is recorded on a magnetic stripe or transferred to an embedded RFID chip or other like technology. At this point, the device contains all the functionality of a standard employee identification card. In the embodiment where employee and employer identification information is not directly viewable on the IPMD, the IPMD includes a clip or retainer system that allows a standard identification card to be maintained in close association with the IPMD, and allows for the standard identification card to be easily inserted and removed from the clip or retainer system.

Operation of the password management functionality proceeds as follows: First, the device is turned on, and the employee is directed to initialize the device by supplying biometric information for future comparison. For optimal security, this function is performed under the control of the employer to ensure that only the employee to whom the IPMD is assigned then provides biometric information for storage on the device.

Once initialization is complete, the employee may use the device to generate and store secure passwords. In operation, the employee will power up the device, then supply the biometric information recorded in the initialization process. If incorrect biometric information is provided, the device will deny the user access to the password storage and password generation capabilities. Thus, it is only the employee that has initialized the device that will be able to use the device for its password capabilities.

After the employee has successfully validated his identity, the employee can then use the random password generating function of the device to create a password. Once generated, the password may be stored in device memory. Alternatively, employees may generate a password manually via the user interface and store such passwords in device memory. The device is capable of generating and storing multiple passwords, and also may contain a descriptor field associated with each password that allows an employee needing multiple secure passwords to store these passwords and to identify the information source to which each such password applies. The display on the device is used to output each such password and its associated descriptor field.

The IPMD is also programmable with respect to access control functions. Access control functionality, whether provided by embedded information on a magnetic strip, a RFID chip, or other storage technology, may be configured to only be operable following a successful verification of biometric information. In this embodiment an employee, immediately prior to presenting the IPMD to a reader/scanner for access to a secured area, is required to supply biometric information to the IPMD. This biometric information is then verified by the IPMD to ensure that only the authorized user of the IPMD is using the IPMD for access control purposes. Upon successful biometric information verification, the IPMD is then authorized to communicate access control information to an access control scanner/reader for a limited period of time, typically on the order of three to five seconds. After this time period has expired, a user is required to re-supply biometric information for verification prior to the IPMD again communicating access control information.

The present invention advantageously eliminates the need to maintain written lists of passwords, and provides strong security that only the authorized employee may obtain the employee's passwords. Further, it eliminates central server storage of biometric information which is potentially subject to unauthorized access. The present invention also provides for a secure system of managing access control by tying access control to biometric information verification without having to install biometric information readers at access control points or store biometric information on central servers; thereby preventing a person who may have improperly obtained an access control card from gaining access in areas where that person is not authorized to enter.

### DRAWINGS

These and other features, aspects, and advantages of the present invention will become better understood with regard to the following description, appended claims, and accompanying drawings wherein:

FIG. 1 is a block diagram illustrating elements of an identification and password management device according to an embodiment of the present invention

FIG. 2 is a front view of the present invention;

FIG. 3 is a back view of the present invention;

FIG. 4 is a flow diagram showing operation of the present invention;

### DESCRIPTION

It is to be understood that the elements or functional modules described in this patent application may be implemented in various forms of hardware, software, firmware, or a combination of these things. Preferably, the biometric verification elements are implemented in software and may include any suitable processor architecture for practicing the invention by programming one or more general purposed processors. It is to be further understood that because some of the components of the present invention are to be implemented as software modules, the actual connections as shown on the figures may differ, depending on the manner in which the invention is programmed. Special purpose processors may also be utilized to implement the invention. Given the teachings of the invention in this patent application, one of ordinary skill in the related art will be able to contemplate these and similar implementations of the elements of the invention.

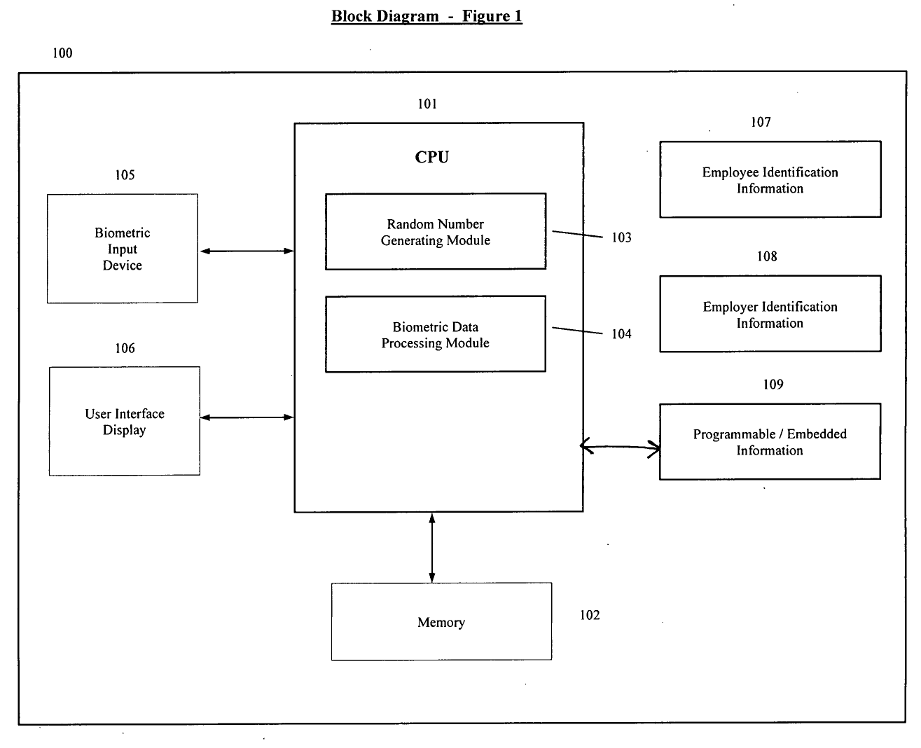

Referring to FIG. 1, a block diagram illustrating elements of the identification and password management device (IPMD) 100 according to an embodiment of the present invention is shown. The IPMD includes a central processing unit (CPU) 101 which controls the operation of the IPMD device via programs stored in memory 102 and executed by CPU 101. These programs include a random number generating module 103, that is capable of producing a random selection of numbers, letters, and symbols to make up a password. Preferably, random number generating module 103 will produce passwords with at least eight characters to maintain adequate security against automated decrypting of passwords. Biometric data processing module 104 is included for processing biometric data to provide user identity verification. Although the illustrative embodiment shown in FIG. 1 shows the CPU 101 comprising the random number generating module 103 and the biometric data processing module 104, it is to be understood that such modules may also be implemented as special purpose modules each having a processor, associated memory, and stored programs for performing such functions.

The IPMD device 100 includes a user interface/display 106, that is operatively coupled with CPU 101. The user interface/display 106 is preferably composed of a conventional LCD display and keys that are programmed to implement discrete functions and to allow entry of information and control operations of IPMD device 100. Alternatively, the interface/display 106 may be a liquid crystal display (LCD) touch screen display (or equivalent user interface), for displaying and/or inputting data associated with the operations or functions of IPMD device 100.

A biometric input device 105 of any conventional type may also be provided for collecting biometric data such as a finger or thumb print, a handwriting sample, a retinal vascular pattern, or any combination of the above, to provide biometric verification of the user. The biometric data received from biometric sensor 105 is processed by CPU 101 in the biometric data processing module 104 and compared against biometric data stored in memory 102 to verify a user's identity prior to accessing passwords stored in memory 102 or to activating programmable/embedded information 109. It is to be understood by those skilled in the art, that the biometric verification features of the IPMD may be replaced or supplemented with a personal identification number or password to provide user verification. Alternatively, the biometric sensor 105 may be integrated into interface/display 106.

In one embodiment, the IPMD includes employee identification information 107 that is displayed in visual form on the IPMD. Preferably, this is accomplished through standard and well-known photo-identification printing technologies that are used to produce driver's licenses, employee identification cards, and the like. The IPMD includes employer identification information 108 that is likewise visually displayed on the IPMD.

The IPMD includes programmable/embedded information 109 that can be used to provide access and security controls. Programmable/embedded information 109 can be stored on a magnetic strip, or can be programmed into an embedded RFID chip. In this embodiment, programmable/embedded information 109 is operatively coupled to CPU 101 and memory 102. This allows the output of programmable/embedded information 109 to be selectively enabled such that programmable/embedded information is not available to an associated information reader until a user's identity has first been verified through the input and verification of the user's biometric data. Alternatively IPMD 100 is configurable to allow for the release of programmable/embedded information 109 without first verifying biometric data.

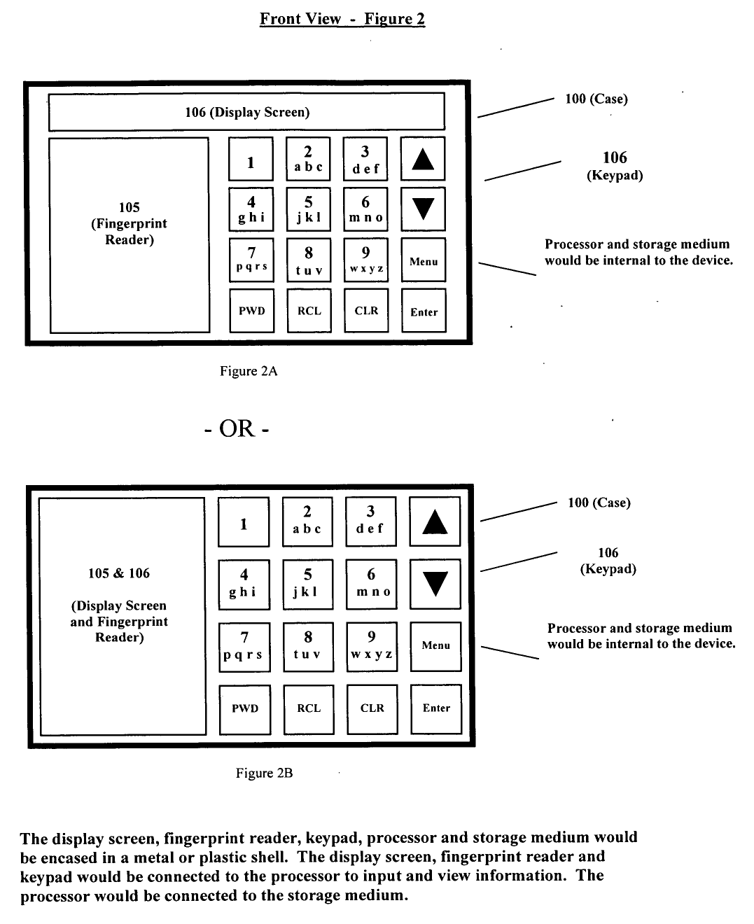

FIG. 2A shows a front view of an embodiment the IPMD 100 of the present invention. In this embodiment, biometric input device 105 consists of a fingerprint reader located on the left side of IPMD 100. User interface/display 106 is composed of a display screen located along the top of IPMD 100, and input keys located on the right side of IPMD 100. FIG. 2B shows an alternate embodiment in which biometric input device 105 is incorporated within user interface/display 106. It should be understood by those skilled in the art, that the locations of these identified components are not critical to the functionality of IPMD 100, and can be varied as required to suit individual needs.

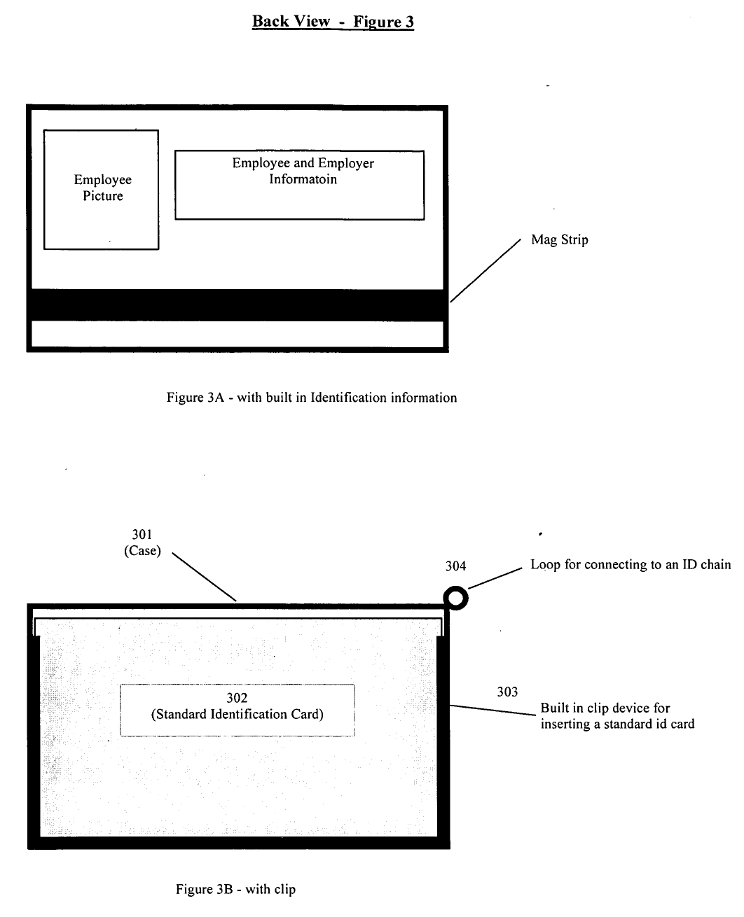

FIG. 3A shows a rear view of IPMD 100, in an embodiment where employee identification information 107 and employer identification information 108 are displayed directly on IPMD 100. FIG. 3A also shows programmable/embedded information 109, in the form of a magnetic strip, located along the bottom edge of IPMD 100. Alternatively, programmable/embedded information 109 can be contained in an RFID chip integrated into IPMD 100. Again, it must be understood that location and arrangements of components may be varied without affecting the functionality of the IPMD 100.

FIG. 3B show a rear view of IPMD 100 in an embodiment where employee identification information 107, employer identification information 108, and programmable/embedded information 109 are not included on IPMD 100. In this embodiment, case 301 is provided to provide a storage device capable of holding both IPMD 100 and a standard identification card 302 in close proximity. Case 301 is comprised of a rigid frame that is slightly larger in height and width than IPMD 100. Case 301 further includes retaining channels 303 along the left and right sides and bottom of case 301. Retaining channels 303 and case 301 create a U-shaped cavity along three sides of case 301 into which IPMD 100 and standard identification card 302 may be easily inserted and removed. Retaining channels 303 are sized to provide sufficient depth to allow IPMD 100 and standard identification card 302 to be held back-to-back in case 301. Case 301 further includes loop 304 designed to receive and attach to lanyards, chains, and the like (not shown) used to secure an identification device to a user. It is to be understood by those skilled in the art, that the storage capability features of the IPMD may be replaced or supplemented with another retention systems such as clips, hook and loop fasteners, and the like, to provide the capability of holding IPMD 100 and a standard employee identification card in close proximity.

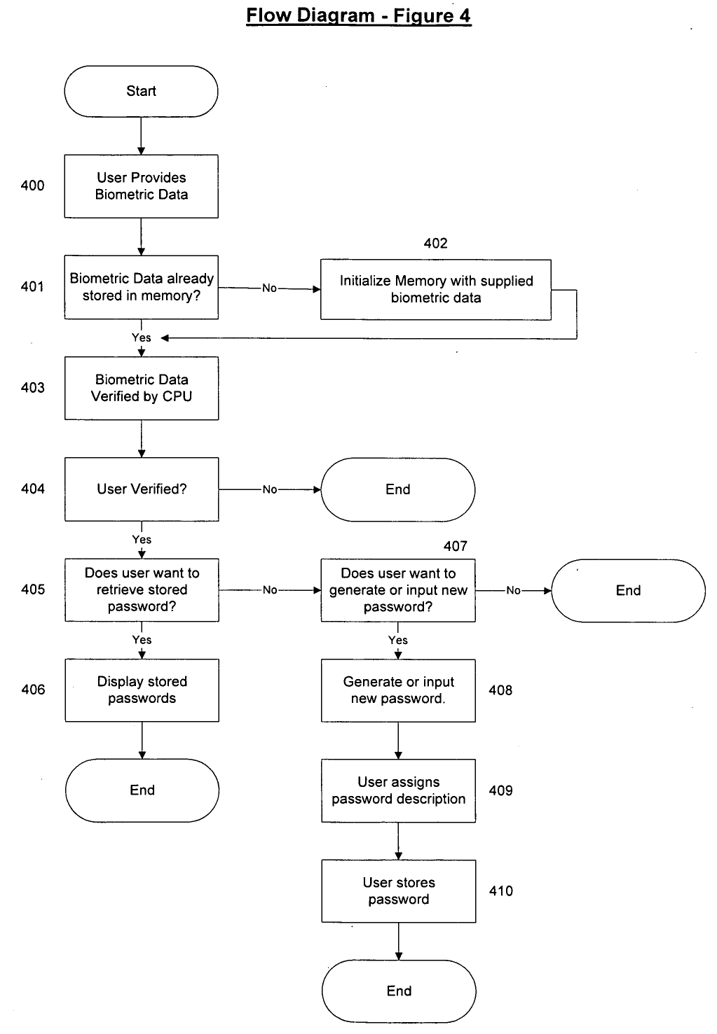

Referring to FIG. 4, operation of password management functionality of the IPMD 100 is now described. A user is first prompted to supply biometric identification information (step 400, FIG. 4). CPU 101 then determines if memory 102 is populated with biometric data (step 401). If memory 102 is not populated with biometric data, memory 102 is populated with the biometric data supplied in step 400 (step 402). If memory 102 is populated with biometric data, then CPU 101 and biometric data processing module 104 compare the supplied biometric data with the stored biometric data (step 403). If the supplied biometric data matches the stored biometric data, further access is allowed. If the supplied biometric data does not match the stored biometric data, no further access is allowed (step 404).

Once the user's biometric data is verified, the user may either retrieve stored passwords (step 406) or generate a new password (step 407). In generating a new password, random number generating module 103 creates the password (step 408) and the user is offered the opportunity to supply a description to be associated with this password (step 409). This feature is optional to the user, and may be helpful in the circumstance where a user is required to maintain multiple passwords. The user then stores the newly created password (step 410) for future retrieval.

It is well known in the art that employee identification cards are generally of the same general dimension as standard credit cards, which typically are approximately two inches high and three inches wide. This sizing facilitates storage of employee identification cards in standard wallets, purses, and other devices for storing and handling credit cards. In an embodiment of the present invention, IPMD 100 maintains standard credit card height and width size specifications. Depending upon the requirements of the components integrated into IPMD 100, the depth of IPMD 100 will vary, but generally will have a greater depth than a standard credit card.

Alternatively, IPMD 100 may be configured to allow for the close association of a standard employee identification card through an included clip or retention system. In this embodiment, IPMD 100 does not itself display employee identification information 107 and employer identification information 108, and optionally includes the functionality of programmable/embedded information 109.

Advantages

The IPMD 100 of the present invention offers numerous advantages. First, it provides a device that allows a user to manage multiple passwords in a secure manner. It generates strong passwords that are extremely difficult to decrypt. It eliminates the need for paper lists of passwords, and the associated security problems associated with paper lists. It provides increased control over security and access functions by allowing for the communication of security and access information only after successfully biometric identification verification. Finally, in one embodiment it integrates the functions of an employee identification and access card, thereby creating no additional burden on users who already are required to possess and/or display such identification cards, and in another embodiment it provides for the easy and convenient association and storage of a standard employee identification card in conjunction with EPMD 100.

Although the illustrative embodiments of the present invention have been described herein with reference to the accompanying drawings, it is to be understood that the invention is not limited to those precise embodiments, and that various other changes and modifications may be affected by one skilled in the art without departing form the scope or spirit of the invention. All such changes and modifications are intended to be included within the scope of the invention as defined by the appended claims.

What is claimed is:

1. A password management device comprising:
a. a housing, wherein said housing is substantially similar in height and width to a standard credit card;
b. a central processing unit disposed within said housing;
c. a memory device, operatively coupled to said central processing unit and disposed within said housing;
d. a user interface, operatively coupled to said central processing unit and disposed within said housing;
e. a display, integrated into said housing and operatively coupled to said central processing unit;
f. means for receiving biometric input data from a user, said receiving means being operatively coupled to said central processing unit and integrated into said housing; and
g. programming means, executable by said central processing unit.

2. The password management device of claim 1 wherein said housing is adapted to receive photographic and textual information on an exterior of said housing.

3. The password management device of claim 1 wherein said user interface is comprised of a liquid crystal display touch screen.

4. The password management device of claim 1 wherein said user interface is comprised of a keypad.

5. The password management device of claim 1 wherein said programming means further includes a random number generator.

6. The password management device of claim 1 wherein said programming means further includes biometric data verification.

7. The password management device of claim 1 further including means for selectively communicating with an access control device.

8. The password management device of claim 7 wherein said communications means is operatively coupled to said central processing unit.

9. The password management device of claim 7 wherein said communications means is selected from a group consisting of an RFID chip and a magnetic strip.

10. The password management device of claim 1 further including means for holding said password management device in close proximity to a standard employee identification card.

11. A password management device comprising:
a. a housing;
b. a central processing unit disposed within said housing;
c. a memory device, operatively coupled to said central processing unit and disposed within said housing;
d. a user interface, operatively coupled to said central processing unit and disposed within said housing;
e. a display, integrated into said housing and operatively coupled to said central processing unit;
f. means for receiving biometric input data from a user, said receiving means being operatively coupled to said central processing unit and integrated into said housing;
g. programming means, executable by said central processing unit; and
h. means for selectively communicating access control information to an access control device, said communications means operatively connected to said central processing unit.

12. The password management device of claim 11 wherein said housing is substantially similar in height and width to a standard credit card.

13. The password management device of claim 11 wherein said user interface is comprised of a liquid crystal display touch screen.

14. The password management device of claim 11 wherein said user interface is comprised of a keypad.

15. The password management device of claim 11 wherein said programming means further includes a random number generator.

16. The password management device of claim 11 wherein said programming means further includes biometric data recognition capabilities.

17. The password management device of claim 11 wherein the device further includes means for holding said password management device in close proximity to a standard employee identification card.

18. The password management device of claim 11 wherein said housing is adapted to receive photographic and textual information on an exterior of said housing.

19. A password management device comprising:
a. a housing, said housing adapted to receive photographic and textual information on an exterior of said housing;
b. a central processing unit and a memory operatively disposed within said housing, said memory operatively coupled to said central processing unit;
c. programming means, executable by said central processing unit;
d. means for receiving biometric data input device from a user, said receiving means operatively connected to said central processing unit;
e. a user interface, said user interface operatively coupled to said central processing unit and disposed within said housing; and
f. a display, said display integrated into said housing and operatively coupled to said central processing unit.

20. The password management device of claim 19 wherein said housing is substantially similar in height and width to a standard credit card.

21. The password management device of claim 19 wherein said housing further includes means for storing access control information and means for selectively communicating said stored access control information to an external access control reader.

22. The password management device of claim 21 wherein said programmable access control information storage means is a magnetic data strip.

23. The password management device of claim 21 wherein said programmable access control information storage means is a RFID chip.

24. The password management device of claim 21 wherein said means for selective communication is operatively coupled to said central processing unit.

25. An access control device comprising:
a. a housing;
b. a central processing unit and a memory operatively disposed within said housing, said memory operatively coupled to said central processing unit;
c. means for receiving biometric data input device from a user, said receiving means operatively connected to said central processing unit;
d. means for storing access control information, said storage means operatively connected to said central processing unit;
e. means for selectively communicating said stored access control information to an external access control information reader.

26. The access control device of claim 25 wherein said means for storing access control information comprises an RFID chip.

27. The access control device of claim 25 wherein said means for storing access control information comprises a magnetic strip.

28. The access control device of claim 25 wherein said housing is adapted to receive photographic and textual information on an exterior of said housing.

29. The access control device of claim 25 further including means for holding said password management device in close proximity to a standard employee identification card.
